(19) United States
(12) Patent Application Publication
(10) Pub. No.: US 2013/0145692 A1
(43) Pub. Date: Jun. 13, 2013

(54) Hands-Free Barrier Operator

(71) Applicants: Edward T. LAIRD, Lombard, IL (US); Robert John OLMSTED, Wood Dale, IL (US); James J. ROBERTS, Burr Ridge, IL (US)

(72) Inventors: Edward T. LAIRD, Lombard, IL (US); Robert John OLMSTED, Wood Dale, IL (US); James J. ROBERTS, Burr Ridge, IL (US)

(73) Assignee: THE CHAMBERLAIN GROUP, INC., Elmhurst, IL (US)

(21) Appl. No.: 13/313,091

(22) Filed: Dec. 7, 2011

(51) Int. Cl. E05F 15/20

(52) U.S. Cl. 49/31; 49/506

(57) ABSTRACT

A barrier control apparatus and method for controlling movement of a barrier are provided to allow a user the ability to move a barrier without physically contacting the barrier. For example, the barrier control apparatus maintains a defined distance between an object such as a hand and a defined location relative to the barrier such that movement of the barrier follows movement of the object. In this way, a user is able to maintain control of the movement of the barrier throughout the opening and closing process. The barrier control apparatus is further able to detect gestures made by the user and can control movement of the barrier accordingly.

### TECHNICAL FIELD

This generally relates to methods and devices for effecting hands-free control of a barrier.

### BACKGROUND

Barriers such as doors and gates generally require user input to operate the barrier. Most barriers are opened and closed manually through direct user contact. For example, a typical door may require a user to turn a door knob or handle or simply exert force on the door itself. Barriers may also be automated. To open an automatic door, for example, a user typically must press a button or input a code on a touchpad. Such automated doors may be implemented for convenience or security purposes or to assist those with physical handicaps. Regardless of the method of opening, these barriers generally require a user to make direct physical contact, generally by hand, with the barrier or a connected device.

In nearly every environment, user contact with a surface can result in the spreading of undesirable microorganisms, such as germs. Germs may be spread from the user to the surface and vice versa. Repeated user contact with such a surface contributes to the spreading of these germs to others who contact the surface. For example, a user wishing to open a door of a public facility must typically turn a door handle in order to open the door. Repeated opening and closing of the door can result in a buildup of germs on the handle. Any user who contacts the handle is exposed to the germs.

Because it is known that germs may be spread through contact with common objects, various systems have been developed to reduce the spreading of germs. For example, many public facilities such as public restrooms now have automated water and soap dispensers that allow users to wash their hands without making contact with any surfaces. While such systems are effective in sanitizing a user's hands, their effectiveness is short-lived as a user must then touch a door or door handle to open the door and exit the restroom. Depending on the hygiene of previous users, germs from that door or door handle may be spread to even those users who take care to sanitize their hands.

In light of these insufficiencies, various additional solutions have been developed to reduce the spreading of germs. For example, an automated door can be programmed to move from an open position to a closed position when a proximity sensor detects a patron within a certain proximity of the door. Another known door-opening process begins when a proximity sensor detects a patron's hand within a defined proximity of an actuator. While these and other motion-activated automatic doors generally eliminate the need for physical contact prior to opening a door, these devices allow for very little, if any, user control over the barrier's movement beyond full open and full close operations. That is, once an automated door is activated, the door will move from a closed position to an open position, or vice versa, regardless of the user's subsequent intentions.

### SUMMARY

Generally speaking, an improved barrier control apparatus that effects controlled movement of a barrier and a method to effect controlled movement of the barrier are described. The barrier control apparatus allows a user to move a door without contacting the door, while still providing control over the movement of the door.

The barrier control apparatus senses an object within a threshold distance and determines a direction of movement of the object and a rate of movement of the object. Based at least in part on the direction of movement of the object and the rate of movement of the object, the controller controls the barrier operator, which in turn controls movement of the door. The controller may also be configured to maintain a defined distance between the object and a defined location relative to the barrier such that movement of the barrier follows movement of the object. In this way, a user is able to maintain control of the movement of the barrier throughout the opening and closing process.

In one example, the barrier control apparatus is further able to detect gestures made by the user based at least in part on the direction of movement of the object and the rate of movement of the object and can control movement of the barrier accordingly. This permits the user to approach a door and perform familiar gestures to move the door. Depending on the direction and speed of the user's hand movement, the door may fully open, fully close, partially open, partially close, or stop moving. For example, a user wishing to fully open a closed door that opens away from the user can perform a gesture that includes quickly pushing their hand toward the door. Similarly, a user wishing to fully open a closed door that opens toward the user can perform a gesture that includes quickly pulling their hand away from the door. Based on the door configuration, the determined direction of proximity change, and the determined rate of proximity change, the controller recognizes these gestures as “fully open” commands. The barrier control apparatus also recognizes motions indicating a user's desire to stop movement of the door.

### BRIEF DESCRIPTION OF THE DRAWINGS

The above needs are at least partially met through provision of the hands-free barrier operator described in the following detailed description, particularly when studied in conjunction with the drawings, wherein:

FIG. 1 comprises a side view of an example barrier control apparatus as configured in accordance with various embodiments of the invention;

FIG. 2 comprises a schematic block diagram of an example control apparatus as configured in accordance with various embodiments of the invention;

FIG. 3 comprises an overhead view of an example barrier control apparatus as configured in accordance with various embodiments of the invention;

FIG. 4 comprises another overhead view of an example barrier's movements as configured in accordance with various embodiments of the invention;

FIG. 5 comprises a flow diagram illustrating a method of using a barrier control apparatus as configured in accordance with various embodiments of the invention.

FIG. 6 comprises another flow diagram illustrating a method of using a barrier control apparatus as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to these various embodiments, a hands-free barrier control apparatus is provided to allow control of a movable barrier without the need to physically contact the barrier or an actuator that controls the barrier. The term “hands-free” is a commonly-used phrase that refers to the ability to perform an action without direct physical contact by a hand or other body part.

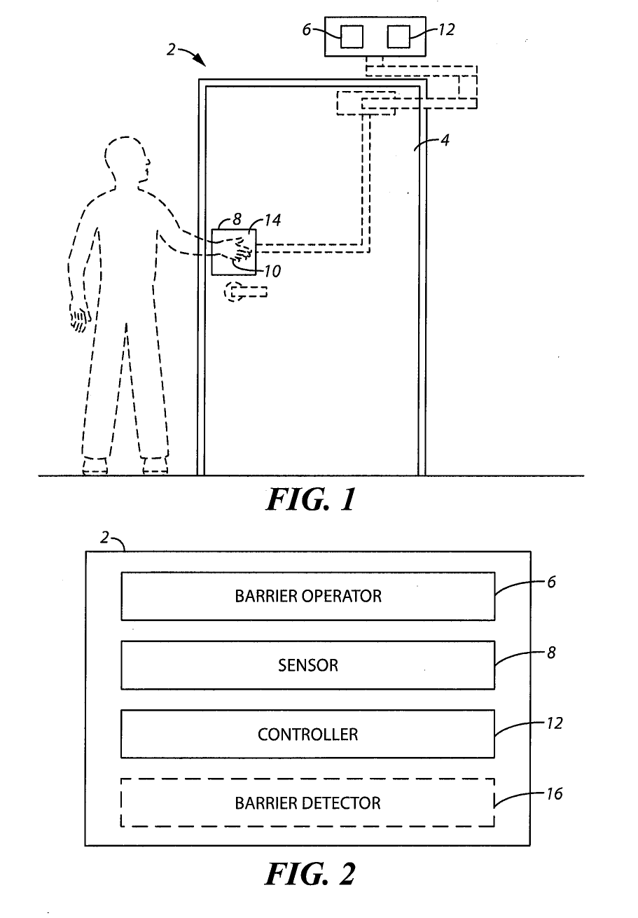

Referring now to the drawings, and in particular to FIG. 1, a barrier control apparatus 2 is provided to allow controlled movement of a barrier 4. As shown in FIGS. 1 and 2, the barrier control apparatus 2 includes a barrier operator 6 configured to move the barrier 4, a sensor 8 configured sense an object 10, and a controller 12 in operative communication with the sensor 8.

The barrier 4 depicted in FIG. 1 is a single hinged door commonly used in residential and commercial settings to close off access to a room. However, it will be appreciated that the approaches described herein are not limited to such hinged doors but may be applied to other types of barriers and operators. For example, these approaches may be applied to sliding doors, overhead doors, vehicle doors, swinging gates, or sliding gates and their associated operators. Other examples of barriers and barrier operators are possible.

As previously mentioned, the approaches described herein provide for a hands-free barrier control apparatus. However, it may be advantageous in certain instances to provide handles on the barrier for manual operation of the barrier. For example, a door which includes both a door knob and the barrier control apparatus described herein allows a user the choice of manually opening the door by operating the door knob or using a hands-free approach described herein.

In addition, the number of barriers 4 and barrier control apparatuses 2 shown in the examples described herein is one. However, it will be appreciated that the approaches described herein can be extended to include any number of movable barriers 4 and any number of barrier control apparatuses 2. Also, multiple movable barriers 4 may be controlled by a single barrier control apparatus 2. Furthermore, multiple barrier control apparatuses 2 may control a single movable barrier 4. For example, one barrier control apparatus 2 may be employed to operate a movable barrier 4 from one side of the barrier 4, and another barrier control apparatus 2 may be employed to operate the movable barrier 4 from the other side of the barrier 4.

The sensor 8 is configured to detect the presence of an object 10. In one approach, the sensor 8 is a proximity sensor. For example, the sensor 8 may be an inductive sensor, a capacitive sensor, a magnetic sensor, or a photoelectric sensor. Furthermore, sensing of an object may be accomplished using optical distance sensing by amplitude or time of flight, sound distance sensing by amplitude or time the flight, or electromagnetic proximity sensing by loss factor or reflectivity. Such sensors are known in the art and need no further explanation herein.

In one approach, the sensor 8 is mounted to the barrier 4. For example, the sensor 8 may be mounted just above a door knob. Alternatively, the sensor 8 may be mounted within a door knob. In another approach, the sensor 8 is not mounted to the barrier 4. In this approach, the sensor 8 may be mounted, for example, on a ceiling above the barrier 4, or on a wall above or next to the barrier 4. In any of these approaches, the sensor 8 may be configured to determine a distance of the object 10 from a defined location 14 relative to the barrier 4. For example, in one approach, a sensor 8 mounted in or on a door or door knob determines a distance between an object 10 and the sensor 8. In this approach, the sensor 8 location is the defined location 14 relative to the barrier 4. In another approach, a sensor 8 mounted to a wall or ceiling determines a distance between an object 10 and a door or door knob. In this approach, the door or door knob, respectively, is the defined location 14 relative to the barrier 4.

As previously stated, the sensor 8 is configured to sense an object 10. The object 10 depicted in FIG. 1 is a human hand. However, it will be appreciated that the object 10 may be any other body part such as an elbow or foot. In another approach, the object 10 may be something other than a human body part. For example, the object 10 may be a clipboard or other moving or movable object.

The controller 12 is in operative communication with the sensor 8. The controller 12 may be located adjacent to, or near, the sensor 8. Alternatively, as depicted in FIG. 1, the controller 12 may be located away from the sensor 8. Communication between the controller 12 and the sensor 8 may be via any communication approach. For example, the communication may be via a wired medium, such as an optical fiber, coaxial conductor, or copper conductor. Alternatively the communication may be wireless, such as via a radio frequency signal, light beam, or Wi-Fi signal.

Using information received from the sensor 8 regarding a sensed object 10, the controller 12 determines a direction of movement of the object 10, as well as a rate of movement of the object 10. The rate of movement may be measured as a speed of the object 10. Alternatively, the rate and direction may be measured as a velocity vector or as an acceleration of the object. For example, as described by the American National Standards Institute, Inc. in ANSI/BHMA A156.10-2005, which is incorporated by reference as if wholly rewritten herein, the controller 12 may determine that a hand is moving toward the barrier 4 at a rate of 6 inches per second.

Based at least in part on the direction of movement of the object 10 and the rate of movement of the object 10, the controller 12 controls the barrier operator 6, which in turn operates the barrier 4. The barrier operator 6 may be any known apparatus for controlling movement of a barrier. The barrier operator 6 may include, for example, a motor or other electro-mechanical, electro-hydraulic, or electro-pneumatic assembly. Furthermore, although the barrier operator 6 depicted in FIG. 1 is operably coupled to the barrier 4 via a linkage, any known device or method for operably coupling the barrier operator 6 to the barrier 4 may be used.

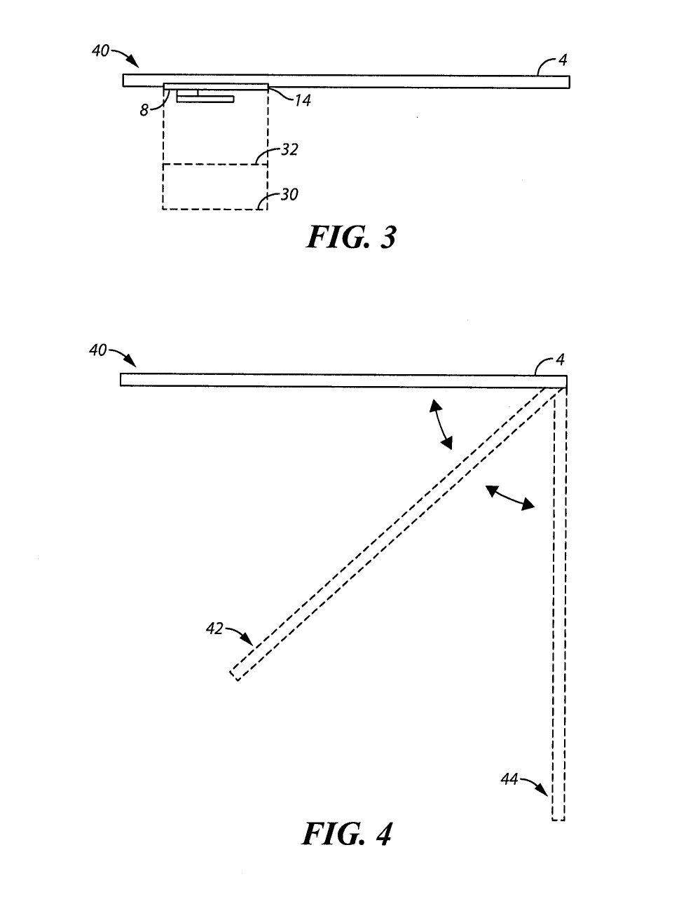

In one approach, shown in FIG. 3, the controller 12 is configured to control the barrier operator 6 in response to determining the distance of the object 10 from the defined location 14 is less than a threshold distance 30. FIG. 3 depicts an example approach in which the defined location 14 from which the threshold distance 30 is measured is defined by the sensor 8. In this example, the controller 12 will not control the barrier operator 6 until an object 10 such as a hand comes within the threshold distance 30, such as 30 centimeters, from the sensor 8. The threshold distance 30 may be programmed at the time of manufacture or may be programmed by the end user. The threshold distance 30 may also be adjustable after manufacture. Furthermore, while FIG. 3 depicts a threshold distance 30 extending parallel to the sensor 8, the threshold distance may also be defined as a radius about the defined location 14.

Upon determining that an object 10 is within the threshold distance 30, the controller 12 controls the barrier operator 6, which in turn moves the barrier 4 so as to maintain a defined distance 32 between the object 10 and the defined location 14. The defined distance 32 is the distance sought to be maintained between the object 10 and defined location 14. The defined distance 32 may be programmed at the time of manufacture or may be programmed by the end user. The defined distance 32 may also be adjustable after manufacture.

Although the defined distance 32 depicted in FIG. 3 is closer to the defined location 14 than the threshold distance 30, the defined distance 32 may instead be defined to be further from the defined location 14 than the threshold distance 30. This approach may be advantageous to avoid accidental openings. For example, the threshold distance may be set to be very close to the defined location 14, such as 10 centimeters. The defined distance 32 may then be set to be further from the defined location, such as 30 centimeters. In this example, a user must place their hand within at least 10 centimeters of the defined location 14, and then must pull their hand back more than 30 centimeters before the controller 12 will control the barrier operator 6 to move the barrier 4 to maintain the defined distance 32.

In the examples shown in FIGS. 3 and 4, the barrier 4 is in a closed position 40. In response to determining an object 10 such as a hand is within the threshold distance 30 from the defined location 14, the controller 12 controls the barrier operator 6 to open the barrier 4 until the barrier 4 is the defined distance 32 from the hand. As the hand pulls back from the defined location 14, the controller 12 controls the barrier operator 6 to move the barrier 4 to follow the hand, maintaining the defined distance 32. Because the barrier control apparatus 2 maintains a defined distance 32 between the object 10 and the defined location 14, a user is in full control of the movement of the door at all times. The controller 12 may fully open, partially open, slowly open, quickly open, fully close, partially close, slowly close, quickly close, or stop movement of the barrier altogether based on the user's hand speed and direction.

By receiving information from the sensor 8, the controller 12 is continuously aware of the distance between the object 10 and the defined location 14. As the distance between the object 10 and the defined location 14 changes, the controller 12 controls the barrier operator 6 accordingly, thus maintaining the defined distance 32 between the object 10 and the defined location 14. The barrier control apparatus 2 is therefore able to cause a barrier 4 to follow movement of an object 10 in both the opening and closing directions.

As discussed, the barrier control apparatus 2 may allow for manual operation of a barrier 4. In this approach, referring again to FIG. 2, the barrier control apparatus 2 may include a barrier detector 16 configured to detect movement of the barrier 4 or an external force on the barrier 4. The barrier detector 16 is in operative communication with the controller 12, which is configured to release control of the barrier operator 6 in response to the barrier detector 16 detecting an external force on the barrier 4 or movement of the barrier 4 when the movement is not caused by the barrier operator 6. The barrier detector 16 may be a sensor disposed on the door or door control mechanism to determine the application of the external force on the door, and such detectors are known in the art and require no further explanation. Such an external force or movement may be caused, for example, by a user pushing or pulling the door or door knob. Upon the controller's 12 release of the barrier operator 6, a user is able to manually operate the barrier 4 without interference from the barrier control apparatus 2.

The barrier detector 16 may also provide a safety feature in which the controller 12 releases control of the barrier operator 6 when the barrier detector 16 detects an external force caused by a person or other obstacle that is in the path of an opening or closing barrier 4. For example, if a user initiates the opening of a barrier 4 and the opening barrier 4 contacts another person standing on the opposite side of the barrier 4, the barrier detector 16 will detect the contact using conventional obstacle collision detecting technology, and in response the controller 12 will release control of the barrier operator 6. The user would then be able to manually operate the barrier 4.

The barrier control apparatus 2 may further be configured to release control of the barrier 4 when the sensor 8 no longer senses an object 10. The barrier control apparatus 2 may release control of the barrier 4 when the distance between the object 10 and the defined location 14 becomes too short or too far. The release can be effected in response to any combination of these options to provide flexibility in designing the use of mechanism for door control.

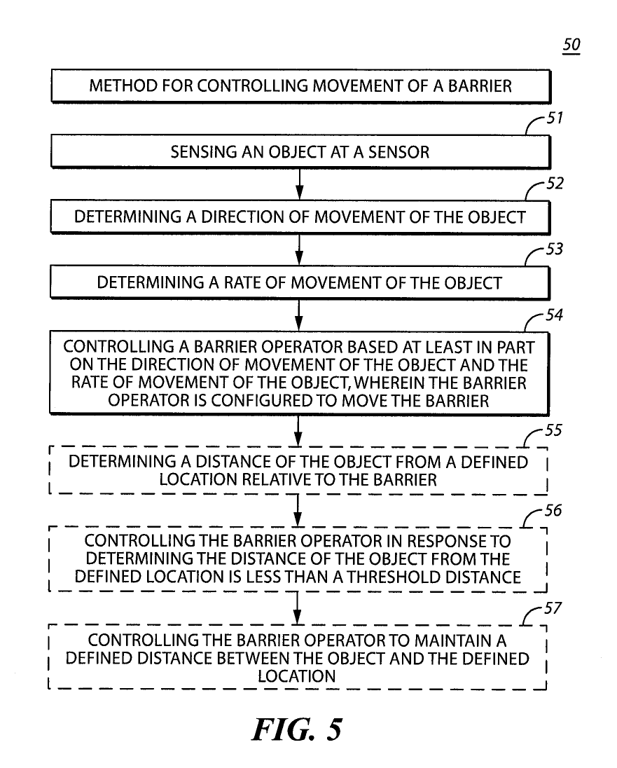

Turning now to FIG. 5, a method 50 for controlling movement of a barrier includes sensing 51 an object 10 at a sensor 8, determining 52 a direction of movement of the object 10, and determining 53 a rate of movement of the object 10. The method 50 further includes controlling 54 a barrier operator 6 based at least in part on the direction of movement of the object 10 and the rate of movement of the object 10. As discussed, the barrier operator 6 is configured to move the barrier 4.

In one approach, the method 50 for controlling movement of a barrier further includes determining 55 a distance of the object 10 from a defined location 14 relative to the barrier. The method 50 further includes controlling 56 the barrier operator 6 in response to determining the distance of the object 10 from the defined location 14 is less than a threshold distance 30. The method further includes controlling 57 the barrier operator 6 to maintain a defined distance 32 between the object 10 and the defined location 14.

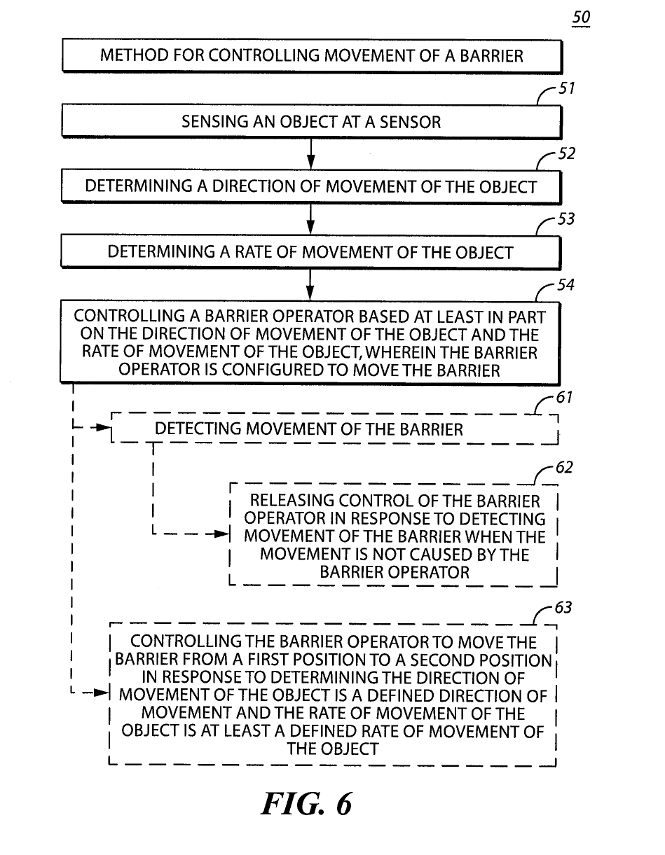

In another approach, with reference to FIG. 6, the method 50 for controlling movement of a barrier further includes detecting 61 movement of the barrier 4. This approach may further include releasing 62 control of the barrier operator 6 in response to detecting movement of the barrier 4 when the movement is not caused by the barrier operator 6.

In yet another approach, the method 50 for controlling movement of a barrier further includes controlling 63 the barrier operator 6 to move the barrier from a first position to a second position in response to determining the direction of movement of the object 10 is a defined direction of movement and the rate of movement of the object 10 is at least a defined rate of movement of the object 10. With reference to FIG. 4, the first position may be a closed position 40, an intermediate position 42, or an open position 44. Similarly, the second position may be a closed position 40, an intermediate position 42, or an open position 44.

In addition to maintaining a defined distance 32 between an object 10 and the defined location 14, as previously described herein, the barrier control apparatus 2 may also respond to defined movements or gestures. By using defined movements or gestures, a user is able to perform familiar movements to operate a door. As will be described, a user may approach a door and move his or her hand is if opening or closing a door, to which the barrier control apparatus 2 would respond accordingly. This maintains the natural feel of operating a door while advantageously preventing the need for physical contact.

In one approach, the controller 12 is configured to control the barrier operator 6 to move the barrier 4 from a first position to a second position in response to determining the direction of movement of the object 10 is a defined direction of movement and the rate of movement of the object 10 is at least a defined rate of movement of the object 10. With reference to FIG. 4, the first position may be a closed position 40, an intermediate position 42, or an open position 44. Similarly, the second position may be a closed position 40, an intermediate position 42, or an open position 44. The defined direction of movement of the object 10 may be, for example, towards the defined location 14, away from the defined location 14, to the left of the defined location 14, to the right of the defined location 14, or any other direction relative to the defined location 14. The defined rate of movement may be, for example, a speed, velocity, or acceleration of the object 10. The defined rate of movement may also be a range of speeds, velocities, or accelerations. Upon recognition of a command, the controller 12 instructs the barrier operator 6 to perform a corresponding defined action, such as partially opening, slowly opening, partially closing, slowly closing, and stopping movement of the barrier 4.

In one example of this approach, an object 10 such as a hand moving generally toward the defined location 14 at a velocity substantially equivalent to the defined rate of movement (or within a range of defined rates of movements) indicates an “open” command. In another example, a hand moving generally away from the defined location 14 at a velocity substantially equivalent to the defined rate of movement (or within a range of defined rates of movements) indicates a “close” command. Other defined directions of movement and rates of movement may indicate additional commands, such as “partially open,” “slowly open,” “partially close,” “slowly close,” or “stop movement.” Commands may also be indicated by movements in multiple defined directions, at multiple rates of movements, or both.

In another approach, the controller 12 is configured to determine an object gesture. This determination is based at least in part on the direction of movement of the object and the rate of movement of an object 10. The controller 12 is further configured to control the barrier operator 6 to perform a defined object gesture response based at least in part on determining the object gesture. The object gestures may include any of the object movements, including directions of movements and rates of movements, described herein. The defined object gesture response may include controlling the barrier operator 6 to stop movement of the barrier 4, or controlling the barrier operator 6 to move the barrier 4 from a first position to a second position. As with the approaches previously described, with reference to FIG. 4, the first position may be a closed position 40, an intermediate position 42, or an open position 44. Similarly, the second position may be a closed position 40, an intermediate position 42, or an open position 44.

The controller 12 may be configured to operate the barrier operator 6 such that movement of the barrier 4 corresponds to known industry standards. For example, as described by the American National Standards Institute, Inc. in ANSI/BHMA A156.10-2005, upon recognition of an open command by the controller 12, the barrier operator 6 may move the barrier 4 to an 80 degree open position in 1.5 seconds, at which point the barrier operator 6 may slow the speed of the barrier 4 until the barrier 4 reaches a 90 degree open position. Upon recognition of a close command, the barrier operator 6 may control the closing time of the barrier 4 according to the equation T=D\sqrt{W}/188, where T is the closing time to latch check in seconds, D is the width of the door in inches, and W is the weight of the door in pounds. When the barrier 4 reaches the latch check position, for example, 10 degrees from the closed position, the barrier operator 6 may slow the speed of the barrier 4. In one example, the barrier does not close through the final 10 degrees in less than 1.5 seconds. Other industry standards may be implemented, such as those described by the American National Standards Institute, Inc. in ANSI/BHMA A156.19-2007 and by the United States Access Board in “Automated Doors: State of the Art Report,” each of which is incorporated by reference as if wholly rewritten herein.

As discussed, multiple barrier control apparatuses 2 may control a single movable barrier 4. In one approach, a barrier 4 is operated by one barrier control apparatus 2 on one side of the barrier 4, and a second barrier control apparatus 2 on the other side of the barrier 4. Thus, a user can open a barrier 4 from one side using the approaches described herein, and close the barrier 4 from the other side, also using the approaches described herein.

The barrier control apparatus 2 may further provide feedback or other information to the user. For example, the barrier control apparatus 2 may alert a user when the sensor 8 has detected an object 10 within the threshold range 30, when the barrier 4 is opening, closing, or stopping, when the controller 12 has recognized an object gesture, when the barrier control apparatus 2 is about to perform an action, or when the barrier detector 16 has detected movement of the barrier 4 not caused by the barrier operator 6.

Information may be conveyed visually or audibly. In one approach, the information is provided in the form of audible words, informing the user what the barrier control apparatus 2 has detected or what actions the barrier control apparatus 2 is or will be performing. Audible information may also be conveyed using a chime or other audio alert. In another approach, the information is provided visually. Visual information can be conveyed to a user, for example, through the illumination of one or more light-emitting diodes, or through a display screen such as a liquid crystal display screen, a light-emitting diode backlit liquid crystal display screen, or other screen capable of conveying information.

So configured, the barrier control apparatus 2 and method 50 for controlling movement of a barrier allow a user to move a barrier without the need for physical contact, while still providing the user control over the barrier's position throughout the barrier-movement process. The barrier control apparatus 2 and method 50 are also capable of recognizing user gestures, which act as commands for specific movements of the barrier. A user is therefore able to approach a door and perform familiar gestures to move the door without contacting the door.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus configured to control movement of a barrier, the apparatus comprising:
a barrier operator configured to move the barrier;
a sensor configured sense an object; and
a controller in operative communication with the sensor;
wherein the controller is configured to determine a direction of movement of the object and a rate of movement of the object, the controller further configured to control the barrier operator based at least in part on the direction of movement of the object and the rate of movement of the object.

2. The apparatus of claim 1, wherein the sensor comprises a proximity sensor configured to determine a distance of the object from a defined location relative to the barrier.

3. The apparatus of claim 2, wherein the controller is configured to control the barrier operator in response to determining the distance of the object from the defined location is less than a threshold distance.

4. The apparatus of claim 3, wherein the controller is configured to control the barrier operator to maintain a defined distance between the object and the defined location.

5. The apparatus of claim 1, further comprising a barrier detector in operative communication with the controller, wherein the barrier detector is configured to detect movement of the barrier.

6. The apparatus of claim 5, wherein the controller is configured to release control of the barrier operator in response to the barrier detector detecting movement of the barrier when the movement is not caused by the barrier operator.

7. The apparatus of claim 1, wherein the controller is configured to control the barrier operator to move the barrier from a first position to a second position in response to determining the direction of movement of the object is a defined direction of movement and the rate of movement of the object is at least a defined rate of movement of the object.

8. The apparatus of claim 7, wherein the first position is selected from a group consisting of: a closed position, an intermediate position, and an open position.

9. The apparatus of claim 7, wherein the second position is selected from a group consisting of: a closed position, an intermediate position, and an open position.

10. An apparatus configured to control movement of a barrier, the apparatus comprising:
a barrier operator configured to move the barrier;
a sensor configured sense an object; and
a controller in operative communication with the sensor;
wherein the controller is configured to determine a direction of movement of the object and a rate of movement of the object, the controller further configured to control the barrier operator based at least in part on the direction of movement of the object and the rate of movement of the object to maintain a defined distance between the object and a defined location relative to the barrier; and
wherein the controller is further configured to determine an object gesture based at least in part on the direction of movement of the object and the rate of movement of the object, the controller further configured to control the barrier operator to perform a defined object gesture response based at least in part on determining the object gesture.

11. The apparatus of claim 10, wherein the defined object gesture response comprises controlling the barrier operator to move the barrier from a first position to a second position.

12. The apparatus of claim 11, wherein the first position is selected from a group consisting of: a closed position, an intermediate position, and an open position.

13. The apparatus of claim 11, wherein the second position is selected from a group consisting of: a closed position, an intermediate position, and an open position.

14. The apparatus of claim 10, wherein the defined object gesture response comprises controlling the barrier operator to stop movement of the barrier.

15. A method for controlling movement of a barrier, the method comprising:
sensing an object at a sensor;
determining a direction of movement of the object;
determining a rate of movement of the object; and
controlling a barrier operator based at least in part on the direction of movement of the object and the rate of movement of the object, wherein the barrier operator is configured to move the barrier.

16. The method of claim 15, further comprising determining a distance of the object from a defined location relative to the barrier.

17. The method of claim 16, further comprising controlling the barrier operator in response to determining the distance of the object from the defined location is less than a threshold distance.

18. The method of claim 17, further comprising controlling the barrier operator to maintain a defined distance between the object and the defined location.

19. The method of claim 15, further comprising detecting movement of the barrier.

20. The method of claim 19, further comprising releasing control of the barrier operator in response to detecting movement of the barrier when the movement is not caused by the barrier operator.

21. The method of claim 15, further comprising controlling the barrier operator to move the barrier from a first position to a second position in response to determining the direction of movement of the object is a defined direction of movement and the rate of movement of the object is at least a defined rate of movement of the object.

22. The method of claim 21, wherein the first position is selected from a group consisting of: a closed position, an intermediate position, and an open position.

23. The method of claim 21, wherein the second position is selected from a group consisting of: a closed position, an intermediate position, and an open position.
